(19) United States
(12) Patent Application Publication
(10) Pub. No.: US 2006/0223547 A1
(43) Pub. Date: Oct. 5, 2006

(54) Environment sensitive notifications for mobile devices

(75) Inventors: Peter G. Chin, Seattle, WA (US); Leonard Smith JR., Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/096,616

(22) Filed: Mar. 31, 2005

(51) Int. Cl. H04Q 7/20

(52) U.S. Cl. 455/456.1

(57) ABSTRACT

Systems and methods for generating notifications based on one or more environmental conditions sensed a mobile computing device. The notifications can also be based on information related to one or more applications that can run on the mobile computing device. The mobile device can also detect non-environmental inputs from the user and ignore them in determining parameters of the notifications.

### TECHNICAL FIELD

The present invention relates to mobile computing devices and, more particularly to controlling or managing notifications generated by mobile computing devices.

### BACKGROUND

Small, handheld computing devices have been steadily growing in popularity in recent years. The devices are known by different names, such as palmtops, pocket computers, personal digital assistants, personal organizers, H/PCs, or the like. Additionally, many portable telephone systems, such as cellular phones, incorporate sufficient computing capabilities to fall within the category of the small, handheld computing devices. These devices, hereinafter “mobile computing devices” provide much of the same functionality as their larger counterparts. In particular, mobile computing devices provide many functions to users including word processing, task management, spreadsheet processing, address book functions, Internet browsing, and calendaring, as well as many other functions.

One commonly used feature of mobile computing devices is to configure a mobile computing device to notify the user of events such as incoming telephone calls, received e-mail, IM (instant messaging) messages, or SMS (short message service) messages, reminders for calendared events, etc. The mobile computing device will generate a notification to the user. Typically, notifications may be presented to a user in many different ways, depending on the event and notification settings (which may be set by a user). Conventional mobile computing devices typically only provide notifications according to these settings.

### SUMMARY

According to aspects of various described embodiments, systems and methods for controlling notifications generated by a mobile computing device are provided. In one aspect, the mobile computing device includes environment sensors that provide information that is used to determine parameters of a notification to be generated for a user.

In another aspect, the mobile computing device uses location information in determining the parameters of the notification. The location information can be obtained using a global positioning system (GPS), address book data from a PIM, calendaring, e-mail or other application that can run on the mobile computing device.

In still another aspect, the mobile computing device determines the parameters of the notification based on application(s) running on the mobile computing device.

In yet another aspect, the mobile computing device selects one or more output devices (e.g., light sources, speakers, vibration, headset, wireless earpiece, etc.) based on the environment and/or applications.

In yet another aspect, the mobile computing device can distinguish between environmental conditions and non-environmental conditions so that the parameters of the notification can be determined without using the non-environmental conditions.

The invention may be implemented as a computer process, a computing system (not limited to mobile computing devices) or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram illustrating an exemplary mobile computing device that may be used with an environment sensitive notification system according to an exemplary embodiment of the present invention.

FIG. 2 is a block diagram illustrating components of a mobile computing device used in an embodiment of the present invention, such as the computer shown in FIG. 1.

FIG. 3 is a block diagram illustrating a software environment according to an embodiment of the present invention.

FIG. 4 is a block diagram illustrating components of an environment sensitive notification system, according to one embodiment of the present invention.

FIG. 5 is a flow diagram illustrating operational flow of an environment sensitive notification system, according to one embodiment of the present invention.

FIG. 6 is a diagram illustrating an environment sensitive notification system, according to another embodiment of the present invention.

FIG. 7 is a flow diagram illustrating operational flow of an environment sensitive notification system, according to another embodiment of the present invention.

### DETAILED DESCRIPTION OF ILLUSTRATED EMBODIMENTS

Embodiments of the present invention are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments of the present invention may be practiced as methods, systems or devices. Accordingly, embodiments of the present invention may take the form of an entirely hardware implementation, an entirely software implementation or an implementation combining software and hardware aspects. The following detailed description is, therefore, not to be taken in a limiting sense.

The logical operations of the various embodiments of the present invention are implemented (1) as a sequence of computer implemented steps running on a computing system and/or (2) as interconnected machine modules within the computing system. The implementation is a matter of choice dependent on the performance requirements of the computing system implementing the invention. Accordingly, the logical operations making up the embodiments of the present invention described herein are referred to alternatively as operations, steps or modules.

### Illustrative Operating Environment

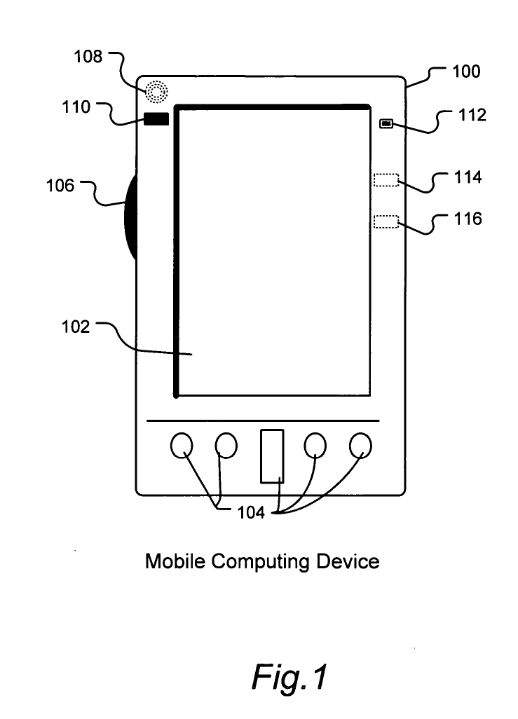

FIG. 1 illustrates an embodiment of a mobile computing device 100 incorporating aspects of the present invention. In this embodiment, mobile computing device 100 is a handheld computer having both input elements and output elements. Input elements may include touch screen display 102 and input buttons or keypad 104 and allow the user to enter information into mobile computing device 100. Mobile computing device 100 also incorporates a side input element 106 allowing further user input. Side input element 106 may be a rotary switch, a button, or any other type of manual input element. In alternative embodiments, mobile computing device 100 may incorporate more or less input elements. For example, display 102 may not be a touch screen in some embodiments. In yet another alternative embodiment, the mobile computing device is a portable phone system, such as a cellular phone having display 102 and input buttons or keypad 104.

Mobile computing device 100 incorporates output elements, such as display 102, which can display a graphical user interface (GUI). Other output elements include speaker 108 and LED light 110. Additionally, mobile computing device 100 may incorporate a vibration module (not shown), which causes mobile computing device 100 to vibrate to notify the user of an event. In yet another embodiment, mobile computing device 100 may incorporate a headphone jack (not shown) for providing another means of providing output signals.

In accordance with embodiments of the invention, mobile computing device 100 also includes environment sensors. In this illustrated embodiment, mobile computing device 100 includes one or more light sensors 112, one or more accelerometers 114, and one or more touch sensors 116. Other embodiments may include more sensors, such as temperature sensors, infrared sensors, pressure sensors, orientation sensors (that can detect the orientation of the mobile computing device), smoke detectors, etc.

Light sensors 112 may be used to determine if mobile computing device 100 is covered (e.g., inside a pocket or briefcase) or uncovered in a dark environment (e.g., in an unlighted room or outdoors at night). Accelerometers 114 may be used to determine if mobile computing device 100 is moving or stationary. Touch sensors 116 may be used to determine whether a user is holding mobile computing device 100 so as to view display 102 or being held next to the user's ear, etc. Audio sensors (e.g., a microphone) may be used to determine noise levels in the vicinity of mobile computing device 100. As will be described in more detail below, information provided by the sensors may be used to automatically modify or configure notifications to be appropriate for the environment and thereby improve user experience.

Accelerometer 114 and touch sensor 116 are indicated in dashed lines in FIG. 1 because such sensors are typically embedded within the device and not visible from the outside. Further, the locations of speaker 108, LED light 110, light sensor 112, accelerometer 114 and touch sensor 116 as shown in the figure are representative and not intended to indicate actual locations for these sensors.

Although described herein in combination with mobile computing device 100, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment, programs may be located in both local and remote memory storage devices. To summarize, any computer system having a plurality of environment sensors, a plurality of output elements to provide notifications to a user and a plurality of notification event types may incorporate embodiments of the present invention.

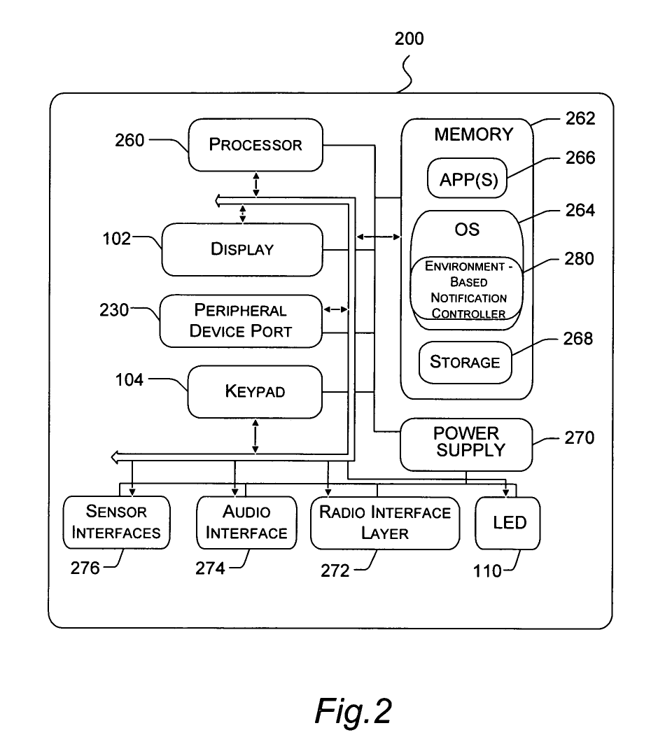

FIG. 2 illustrates a system 200 used in an embodiment of the present invention, such as the mobile computing device shown in FIG. 1. That is, mobile computing device 100 (FIG. 1) can incorporate system 200 to implement an embodiment of the invention. For example, system 200 can be used in implementing a “smart phone” that can run one or more applications similar to those of a desktop or notebook computer such as, for example, browser, email, scheduling, instant messaging, and media player applications. System 200 can execute an OS such as, for example, Windows XP®, Windows Mobile 2003® or Windows CE® available from Microsoft Corporation, Redmond, Wash. In some embodiments, system 200 is integrated as a computing device, such as an integrated personal digital assistant (PDA) and wireless phone.

In this embodiment, system 200 has a processor 260, a memory 262, display 102, and keypad 104. Memory 262 generally includes both volatile memory (e.g., RAM) and non-volatile memory (e.g., ROM, Flash Memory, or the like). System 200 includes an OS 264, which in this embodiment is resident in a flash memory portion of memory 262 and executes on processor 260. Keypad 104 may be a push button numeric dialing pad (such as on a typical telephone), a multi-key keyboard (such as a conventional keyboard), or may not be included in the mobile computing device in deference to a touch screen or stylus. Display 102 may be a liquid crystal display, or any other type of display commonly used in mobile computing devices. Display 102 may be touch-sensitive, and would then also act as an input device.

One or more application programs 266 are loaded into memory 262 and run on operating system 264. Examples of application programs include phone dialer programs, e-mail programs, PIM (personal information management) programs, word processing programs, spreadsheet programs, Internet browser programs, and so forth. System 200 also includes non-volatile storage 268 within memory 262. Non-volatile storage 268 may be used to store persistent information that should not be lost if system 200 is powered down. Applications 266 may use and store information in non-volatile storage 268, such as e-mail or other messages used by an e-mail application, contact information used by a PIM, documents used by a word processing application, and the like. A synchronization application (not shown) also resides on system 200 and is programmed to interact with a corresponding synchronization application resident on a host computer to keep the information stored in non-volatile storage 268 synchronized with corresponding information stored at the host computer. In some embodiments, non-volatile storage 268 includes the aforementioned flash memory in which the OS (and possibly other software) is stored.

System 200 has a power supply 270, which may be implemented as one or more batteries. Power supply 270 might further include an external power source, such as an AC adapter or a powered docking cradle that supplements or recharges the batteries.

System 200 also includes a radio 272 that performs the function of transmitting and receiving radio frequency communications. Radio 272 facilitates wireless connectivity between system 200 and the “outside world”, via a communications carrier or service provider. Transmissions to and from radio 272 are conducted under control of OS 264. In other words, communications received by radio 272 may be disseminated to application programs 266 via OS 264, and vice versa.

Radio 272 allows system 200 to communicate with other computing devices, such as over a network. Radio 272 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 200 is shown with two types of notification output devices: LED 110 that can be used to provide visual notifications and an audio interface 274 that can be used with speaker 108 (FIG. 1) to provide audio notifications. These devices may be directly coupled to power supply 270 so that when activated, they remain on for a duration dictated by the notification mechanism even though processor 260 and other components might shut down to conserve battery power. LED 110 may be programmed to remain on indefinitely until the user takes action to indicate the powered-on status of the device. Audio interface 274 is used to provide audible signals to and receive audible signals from the user. For example, in addition to being coupled to speaker 108, audio interface 274 may also be coupled to a microphone to receive audible input, such as to facilitate a telephone conversation. In accordance with embodiments of the present invention, the microphone may also serve as an audio sensor to facilitate control of notifications, as will be described below.

This embodiment of system 200 also includes sensor interfaces 276 used to receive signals from environment sensors (e.g., accelerometers, light sensors, pressure sensors, etc.). In accordance with embodiments of the invention, the sensor signals can be used in controlling or generating notifications, as described below.

In accordance with embodiments of the present invention, OS 264 includes an environment-based notification controller 280. Environment-based notification controller 280 is used to control or generate notifications according to one or more sensed environmental conditions. Environment-based notification controller 280 receives sensor signals via the sensor interfaces 276 and/or audio interface 274 and can use the signals to control or modify notifications provided to the user. For example, based on the received sensor information environment-based notification controller 280 can control parameters of one or more notification output devices appropriate for various locations and environmental conditions (e.g., in a meeting, in a movie theater, walking outdoors, etc.) indicated by the sensor information. For example, environment-based notification controller 280 may cause increase (or decrease) the volume of a notification if the environment is noisy (or quiet); or decrease (or increase) the luminosity of a display or LED notification if the environment is dark (or well-lit). In other embodiments, other information in addition to the information from the sensors may be used in controlling various parameters of notifications.

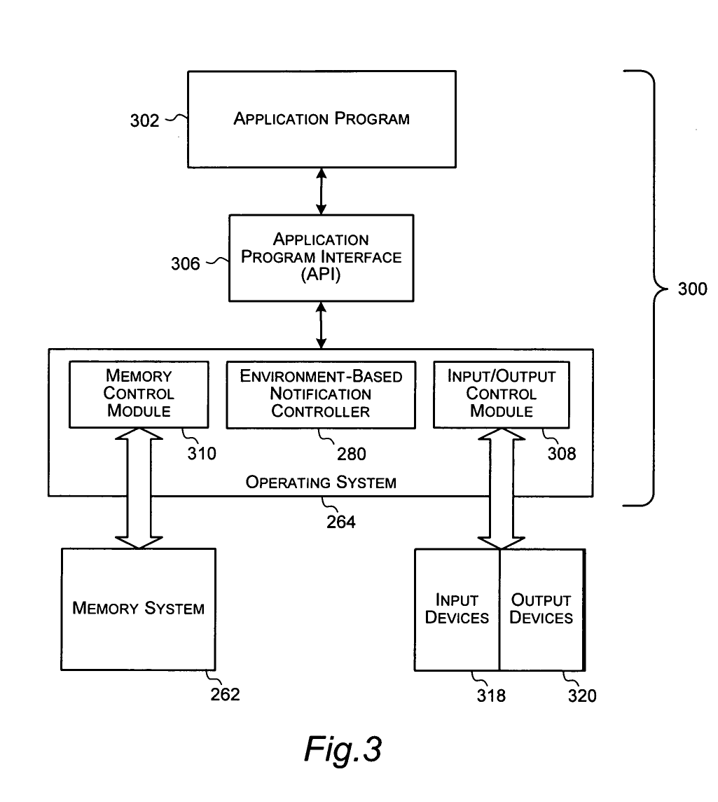

FIG. 3 illustrates an exemplary software environment 300 that can be used to implement embodiments of the present invention. In some embodiments, application program 302 has a notification feature to notify a user of an event. For example, if the application program is a calendaring application, it might issue notifications to remind the user of appointments. Other examples include e-mail applications that notify the user when an e-mail message is received, or a cell phone application(s) that notify the user when a phone call or text message is received.

Application program 302 can communicate with operating system 264 through an application program interface (API) 306. Application program 302 can make calls to methods of API 306 to request OS 264 to generate notifications. In one embodiment, the application program interface conforms to the messaging application program interface (MAPI) developed by Microsoft Corp., Redmond, Wash. In alternative embodiments, the application program 302 communicates directly with OS 304. In the embodiment shown in FIG. 3, application program 302 can make calls to OS 264 to generate notifications.

Application program 302 communicates with a user through OS 264, input/output control module 308 and input/output devices 308 and 310. Input devices 318 can include environment sensors such as described above. In this embodiment, application program 302 receives input signals to customize various notification modes. Each mode, in some embodiments, has an associated profile and is stored by application program 302 in memory system 262 through OS 264 through a memory control module 310. In addition, environment-based notification controller 280 of OS 264 can interact with input/output control module 308 to control or generate notification signals that are appropriate for the estimated situation. Although shown separately in FIG. 3, the described functions of environment-based notification controller 280 may be incorporated into input/output control module 308 in some embodiments.

### Illustrative Embodiments of Methods and Systems to Generate Environment-Sensitive Notifications

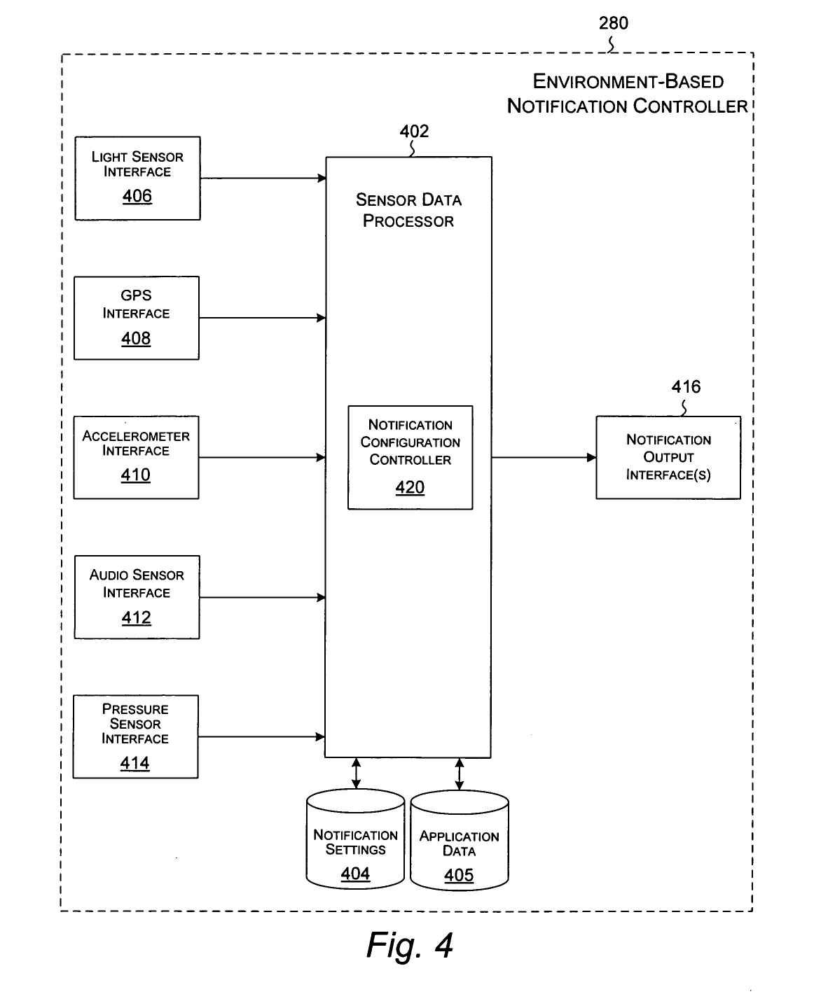

FIG. 4 illustrates components of environment-based notification controller 280, according to one embodiment of the present invention. In some embodiments, environment-based notification controller 280 is incorporated into a Windows-based OS available from Microsoft Corp., although in other embodiments environment-based notification controller 280 may be incorporated into other suitable operating systems. In this embodiment, the illustrated components are software modules or components. However, in other embodiments, the components may be hardware or a combination of software and hardware components.

In this embodiment, environment-based notification controller 280 includes: a sensor data processor 402; a data store 404 to store notification settings; a data store 405 to store data associated with one or more applications executable on the mobile computing device used to implement environment-based notification controller; a light sensor interface 406; a global positioning system (GPS) interface 408; an accelerometer interface 410; an audio sensor interface 412; a touch sensor interface 414; and at least one notification output interface 416. In one embodiment, these interfaces are implemented in input/output control module 308 (FIG. 3). In other embodiments, there can be fewer or more sensor interfaces, depending on the number and types of sensors implemented on the device. Other examples of sensors include smoke detectors, pressure sensors (e.g., strain sensors), barometric pressure sensors, temperature sensors, orientation sensors, infrared sensors, etc.

Further, sensor data processor 402 includes a notification configuration controller 420. Notification configuration controller 420 basically uses sensor information obtained interfaces 406, 408, 410, 412 and 414 to: determine the user's current environmental situation; and based on the determined situation automatically control or configure properties (e.g., volume, luminosity, vibration, output device, etc.) of notifications to be issued to the user. As previously described, these notifications are generated in response to notification requests from applications (e.g., application program 302 of FIG. 3).

Light sensor interface 406 is used in this embodiment to receive signals from one or more light sensors of the mobile computing device used in implementing environment-based notification controller 280. For example, light sensor interface 406 may be used to receive signals from a light sensor such as light sensor 112 (FIG. 1). In some embodiments, the light sensor is implemented using a photodiode and analog-to-digital converter (ADC).

GPS interface 406 is used in this embodiment to receive signals from a GPS service and GPS receiver (not shown) of the mobile computing device used in implementing environment-based notification controller 280. In some scenarios, the GPS information can be used with a geographical information system (GIS) database to obtain relatively specific information regarding the location (within a particular building, for example) of the GPS receiver. In such scenarios, environment-based notification controller 280 can use this location information in determining the user's environmental situation. In addition, some of the location information can include context information. As used here, the context information would include likely environmental conditions of the location. For example, if the location is a movie theater, the context information may include the likely environmental conditions of a movie theater. The context information would be different for a library, a sports arena, a church, etc. Such context information can be used in determining appropriate notifications.

Accelerometer interface 410 is used in this embodiment to receive signals from one or more accelerometers of the mobile computing device used in implementing environment-based notification controller 280. For example, accelerometer interface 410 may be used to receive signals from an accelerometer such as accelerometer 114 (FIG. 1).

Audio sensor interface 412 is used in this embodiment to receive signals from one or more microphones or other audio sensors of the mobile computing device used in implementing environment-based notification controller 280.

Touch sensor interface 414 is used in this embodiment to receive signals from one or more touch sensors of the mobile computing device used in implementing environment-based notification controller 280. For example, touch sensor interface 410 may be used to receive signals from a touch sensor such as touch sensor 116 (FIG. 1). In some embodiments, the touch sensor can detect when a part of the user's body (e.g., hand or ear) is in contact with the touch sensor by detecting changes in conductivity between points on the sensor. In other embodiments, switches (e.g., membrane switches) may be used to detect when a user is applying a force to (i.e., touching) selected areas of the mobile computing device.

In operation, the illustrated embodiment of sensor data processor 402 processes information provided by the sensors associated with interfaces 406, 408, 410, 412 and 414 to determine the current environmental conditions or situation and, in response thereto, control the parameters of notifications to be generated in response to notification requests. In one embodiment, the parameters for the notifications are stored in datastore 404 and implement a mapping between received environment sensor data and notification parameters. For example, samples of the data from each of the sensors can be used as an index to a look-up table storing the notification parameters. Thus, in this example, notification configuration controller 420 would receive a certain set of sensor data samples and use this data to access the look-up table stored in datastore 404 to obtain a set of notification parameters. In some embodiments, the user may select or enter settings that are used in controlling the notification parameters.

Notification configuration controller 420 can then configure the notification according to these parameters and cause the notification to be generated via notification output interface(s) 416. As previously described, the reminder notification can be an audio and/or visual and/or vibration signal, with parameters that are deemed appropriate for the environmental situation.

In other embodiments, notification configuration controller 420 can also use information from other applications running on the mobile computing device used in implementing environment-based notification controller 280. For example, notification configuration controller 420 may use appointment information from a calendaring application running on the mobile computing device to get expected location information that can be used to help determine the environmental situation. Notification configuration controller 420 may also obtain the current time to use in determining the environmental situation. In the illustrated embodiment, notification configuration controller 420 can access this information from data store 405. As another example, in embodiments in which it is part of the OS, notification configuration controller 420 may also detect or become aware of other applications (e.g., a media player, an e-mail application, a Bluetooth application etc.) that are currently running on the mobile computing device. For example, some OSs can manage and monitor running applications, and some applications report the “state” they are in to the OS.

Although the above-described embodiment has been described in terms of separate modules or components, in other embodiments the functions of the various modules or components may be performed by other modules and/or combined into fewer modules. In still other embodiments, some of the functions performed by the described modules may be separated further into more modules.

A scenario is described below to illustrate some of the features of environment-based notification controller 280. In this scenario, a user is in a meeting and puts his mobile computing device on a conference room table. Environment-based notification controller 280 receives a request to generate a notification. Based on sensor information indicating that the mobile computing device is on stationary (from the accelerometer) and laying face-up on a table (from the touch sensor and/or an orientation sensor) and application information indicating that user is at a meeting (from a calendaring application), environment-based notification controller 280 configures the notification to be a visual notification rather than an audio notification or vibration notification (which may be disruptive if the mobile device is on a hard surface like a table top).

In another scenario, the user is out jogging with the mobile computing device in a pocket or fanny pack. Further, the user is wearing an earpiece or headset to listen to music played using a media player running on the user's mobile computing device. Environment-based notification controller 280 then receives a request to generate a notification. Environment-based notification controller 280 detects that mobile computing device is in a pocket or fanny pack (from the light sensor) and that the user is jogging (from the accelerometer). Further, in this embodiment, environment-based notification controller 280 detects that the media application is running and that the earpiece is in use. Based on this information, environment-based notification controller 280 configures the notification to be an audio notification presented to the user via the earpiece. In a further refinement, a speech synthesizer (not shown) can be used to “state” the notification to the user (e.g., “you have a text message”). Still further, the speech synthesizer can also be used to “read” the text message to the user (e.g., automatically or in response to a user command).

These scenarios are not intended to be limiting; rather, they are intended to illustrate the flexibility of environment-based notification controller 280 to configure notifications in response to determined or estimated environmental situations and information obtained from the software environment of the mobile computing device.

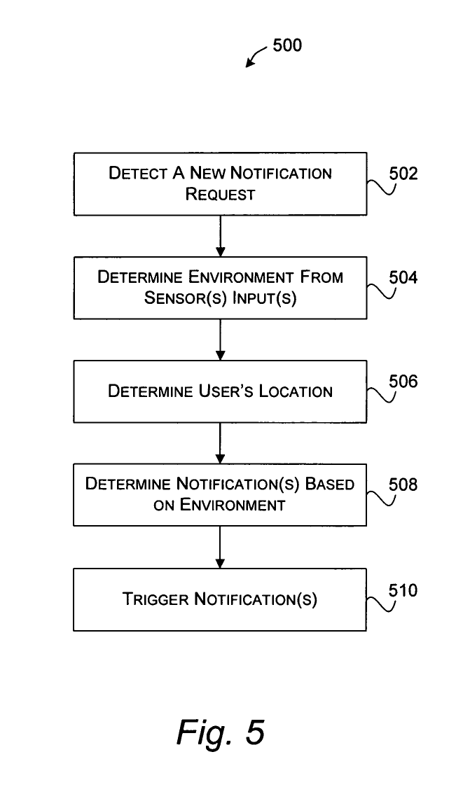

FIG. 5 illustrates operational flow 500 in generating notifications based on sensed environmental conditions, according to one embodiment of the present invention. Operational flow 500 may be performed in any suitable computing environment. For example, operational flow 500 may be executed by system 200 (FIG. 2) to implement environment-based notification controller 280 (FIG. 4). Therefore, the description of operational flow 500 may refer to at least one of the components of FIGS. 2 and 4. However, any such reference to components of FIGS. 2 and 4 is for descriptive purposes only, and it is to be understood that the implementations of FIGS. 2 and 4 are a non-limiting environment for operational flow 500.

At a block 502, a new request for a notification is detected. For example, an OS running on a mobile computing device can perform this operation. In one embodiment, a notification component of an OS such as, for example, environment-based notification controller 280 (FIG. 4) of OS 264 (FIG. 2) detects the new notification request.

At a block 504, sensed environmental information is received. In one embodiment, a component of an OS (such as, for example, sensor data processor 402 of FIG. 4) receives information from sensors of a mobile computing device. For example, the sensors can provide information regarding movement of the mobile computing device, orientation of the mobile computing device, light incident on the mobile computing device, how the user is holding the mobile computing device, audio signals present in the vicinity of the mobile computing device, etc.

At a block 506, the user's location is determined. In one embodiment, a component of an OS (such as, for example, notification configuration controller 420 of FIG. 4) determines the location of the user. For example, the location can be determined using information from a calendaring application (e.g., at a meeting), from a GPS service or other means (e.g., a cellular phone location service).

At a block 508, parameters of the notification are determined based on information from blocks 504 and/or 506. In one embodiment, a component of an OS (such as, for example, the aforementioned notification configuration controller 420) determines the notification parameters using the sensor information and location information (if any). For example, based on information from blocks 504 and 506, notification configuration controller 420 selects one or more notification output devices (e.g., light sources, speakers, vibration, headset, Bluetooth earpiece, etc.) to use in providing the notification. In addition, notification configuration controller 420 can control the settings for these output devices (e.g., volume of the audio output, intensity or luminosity of the light output) based on that information. For example, in a well-lit environment, notification configuration controller 420 may cause the intensity of the light output to be relatively bright so that it will be more visible, or conversely, in a dark environment, cause the intensity to be relatively low to be less disruptive to others while still allowing the user to detect the notification.

At a block 510, the notification is triggered after the parameters of the notification have been configured. In one embodiment, a component of an OS (such as, for example, the aforementioned environment-based notification controller 280) causes the notification to be generated and outputted with the parameters determined at block 508. In some embodiments, the operational flow ends at this point to await another notification request.

Although the above operational flow is described sequentially, in other embodiments some operations may be performed in different orders or concurrently or even omitted.

### Illustrative Embodiments Using Detection of Non-Environmental Inputs in Generating Notifications

Aspects of the present invention also include monitoring environmental conditions in order to distinguish a non-environmental input (e.g. user impact) from environmental conditions. Non-environmental inputs can include voice commands, manipulation of the mobile computing device (e.g., shaking, tapping, etc.). As these non-environmental inputs tend to be purposeful and temporary, they are not necessarily indicative of the environmental conditions. Thus, in accordance with some aspects of the present invention, non-environmental inputs are detected and ignored with regard to generating notifications.

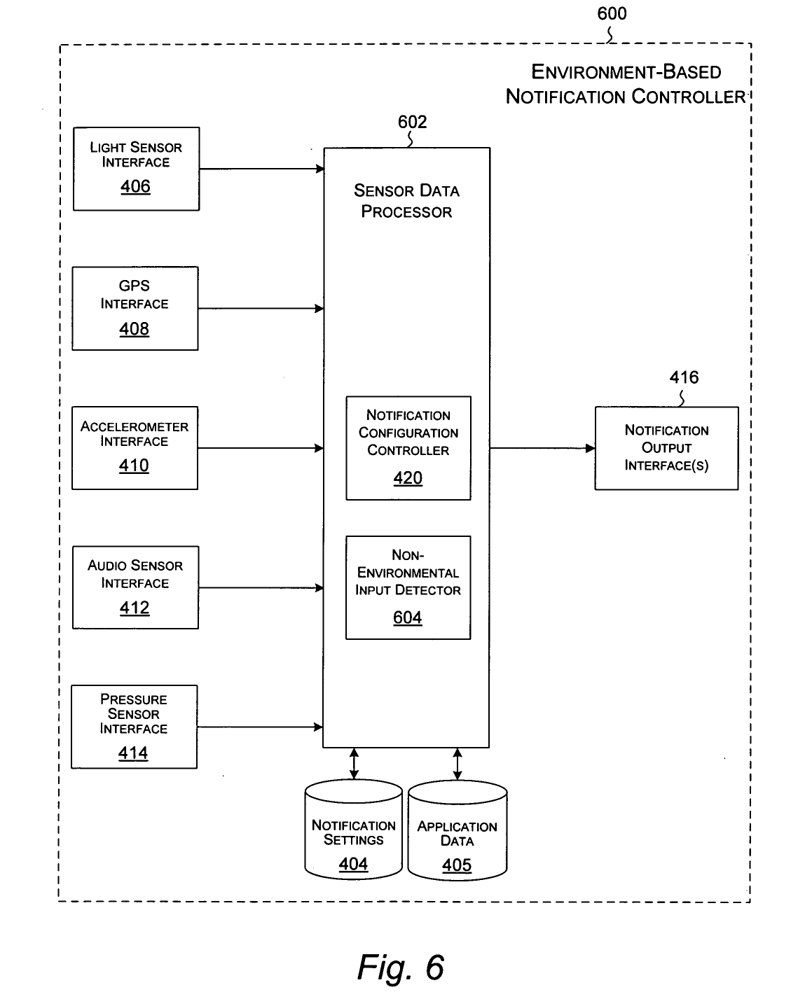

FIG. 6 represents one exemplary system 600 for use by a mobile computing device in generating notifications using environmental awareness. System 600 represents a system overview of the present invention. System 600 may include various configurations without departing from the spirit and scope of the present invention. System 600 may be integrated as a combination of software and hardware elements, an operating system or any combination thereof. Hardware, databases, software or applications referenced herein may be integrated as a single element or include various elements in communication with one another. Software and hardware elements are depicted herein for explanatory purposes only and not for limiting the configuration to multiple elements or a single element performing several functions.

System 600 is substantially similar to environment-based notification controller 280 (FIG. 4), except that sensor data processor 402 (FIG. 4) is replaced with a sensor data processor 602. Further, sensor data processor 602 is substantially similar to sensor data processor 402 except that sensor data processor 602 includes a non-environmental input detector 604 to distinguish between environmental conditions and user inputs. Except as described below, system 600 operates in substantially the same manner as environment-based notification controller 280 (FIG. 4).

In one embodiment, non-environmental input detector 604 receives data from the sensors via interfaces 406, 408, 410 and 414 and determines whether the sensor data includes non-environmental inputs. For example, an accelerometer measures or identifies accelerations, vibrations and/or movements of the mobile computing device. For example, the accelerometer data may indicate to non-environmental input detector 604 that a user is walking, riding a bicycle, or on a train by the rhythmic pattern of these activities. By identifying a rhythmic pattern, non-environmental input detector 604 may also identify non-environmental inputs that vary from the rhythmic pattern of the activity.

A non-environmental input may include any type of impact that non-environmental input detector 604 identifies as not being provided by the environment. For example, a non-environmental input may include tapping the device, moving the device in a particular manner, holding the device, etc. For instance, non-environmental input detector 604 may identify that the user is riding a bicycle by the repeated vibrations and movements detected by the accelerometer that are indicative of riding a bicycle. Non-environmental input detector 604 may determine that these vibrations and movements are environmental inputs because of the pattern. However, if a user taps mobile computing device 602 while riding the bicycle, non-environmental input detector 604 may detect the taps and determine that they are non-environmental inputs.

Non-environmental input detector 604 may use a suitable probability algorithm, estimator or statistical calculator to determine the likelihood of environmental conditions and non-environmental inputs. In one embodiment, non-environmental input detector 604 uses a Bayesian algorithm to make a decision as to whether a received sensor data is generated by a non-environmental input. Notification configuration controller 420 can then use this information along with the sensor data to determine appropriate parameters for notifications. For example, notification configuration controller 420 can simply ignore all sensor data determined (by non-environmental input detector 604) to be non-environmental input and determine the notification parameters based on other sensor data.

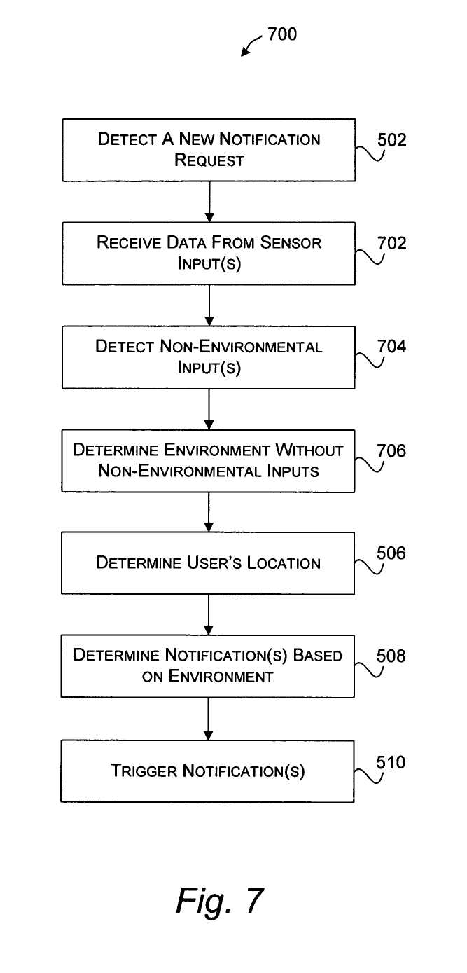

FIG. 7 illustrates operational flow 700 in generating notifications based on sensed environmental conditions, according to one embodiment of the present invention. Operational flow 700 may be performed in any suitable computing environment. For example, operational flow 700 may be executed by system 600 (FIG. 6). Therefore, the description of operational flow 700 may refer to at least one of the components of FIG. 6. However, any such reference to components of FIG. 6 is for descriptive purposes only, and it is to be understood that the implementations of FIG. 6 are a non-limiting environment for operational flow 700.

Blocks 502, 506, 508 and 510 are performed as described above in conjunction with FIG. 5. Therefore, only the new blocks 702, 704 and 706 are described below.

At block 702, data is received from sensors of a mobile computing device. For example, the sensors can provide information regarding movement of the mobile computing device, orientation of the mobile computing device, light incident on the mobile computing device, how the user is holding the mobile computing device, audio signals present in the vicinity of the mobile computing device, etc.

At block 704, the sensor data is processed to detect any non-environmental input(s). As previously described, a non-environmental input may include tapping the device, moving the device in a particular manner, holding the device, etc. In one embodiment, a detector such as non-environmental input detector 604 processes the sensor data to detect non-environmental inputs.

At block 706, the environment is determined using the sensor data (from block 702) and any detected non-environmental inputs (from block 704). In one embodiment, a component such as notification configuration controller 420 determines the environment. In some embodiments, the component ignores non-environmental inputs in determining the environment.

Then the notification parameters are determined in further operations as described above for blocks 506, 508 and 510. In this way, non-environmental inputs do not inappropriately influence the parameters of the notifications generated by the mobile device.

Although the invention has been described in language that is specific to structural features and/or methodological steps, it is to be understood that the invention defined in the appended claims is not necessarily limited to the specific features or steps described. Rather, the specific features and steps are disclosed as forms of implementing the claimed invention. Since many embodiments of the invention can be made without departing from the spirit and scope of the invention, the invention resides in the claims hereinafter appended.

What is claimed is:

1. A computer-implemented method of generating notifications, the method comprising:
receiving information derived from at least one environment sensor of a mobile computing device; and
selectively generating a notification for a user in response to notification request, wherein the notification has parameters based at least on the received information.

2. The method of claim 1 wherein selectively generating a notification further comprises selectively generating the notification having parameters based at least on information related to the user's location.

3. The method of claim 2 wherein the location information includes context information regarding the location.

4. The method of claim 1 wherein selectively generating a notification further comprises selecting one or more output devices to generate the notification for the user.

5. The method of claim 1 wherein selectively generating a notification further comprises selectively generating the notification having parameters based at least on information related to one or more applications executable by the mobile computing device.

6. The method of claim 4 wherein the one or more applications are selected from the group comprising: a calendaring application, a global positioning system (GPS) application, a personal information manager (PIM) application, an e-mail application or a geographical information system (GIS) application.

7. The method of claim 1 wherein selectively generating further comprises basing the notification parameters at least in part on detecting and ignoring a non-environmental input in information derived from the at least one environmental sensor.

8. The method of claim 1 wherein the function depends at least in part on the received information or information related to one or more applications that are executable by the mobile computing device, or both.

9. A computer-readable medium having stored thereon instructions that when executed by a mobile computing device perform operations implementing the method of claim 1.

10. A system to generate a notification, the system comprising:
an interface to an environment sensor of a mobile computing device; and
a sensor data processor to selectively generate a notification for a user in response to notification request, wherein the notification has parameters based at least on the received information.

11. The system of claim 10 wherein the parameters are also based at least on information related to the user's location.

12. The system of claim 10 wherein the parameters are based at least on information related to one or more applications executable by the mobile computing device.

13. The system of claim 10 wherein the environmental sensor monitors one or more of: acceleration, conductance, audio, light, pressure, infrared, orientation, or temperature.

14. The system of claim 10 wherein the notification parameters are based at least in part on detecting and ignoring a non-environmental input from the received information.

15. A computer-readable medium having stored thereon instructions that when executed implement the system of claim 10.

16. A system for generating notifications, the system comprising:
means for receiving information derived from at least one environment sensor of a mobile computing device; and
means for selectively generating a notification for a user in response to notification request, wherein the notification has parameters based at least on the received information.

17. The system of claim 16 wherein the means for selectively generating a notification further comprises means for selectively generating the notification having parameters based at least on information related to the user's location.

18. The system of claim 16 wherein the means for selectively generating a notification further comprises means for selectively generating the notification having parameters based at least on information related to one or more applications executable by the mobile computing device.

19. The system of claim 16 wherein the means selectively generating a notification further comprises means for selecting one or more output devices to generate the notification.

20. The system of claim 16 wherein the means for selectively generating a notification further comprises means for ignoring non-environmental input in the information derived from the at least one environment sensor.
